(19) United States
(12) Patent Application Publication
(10) Pub. No.: US 2013/0155192 A1
(43) Pub. Date: Jun. 20, 2013

(54) STEREOSCOPIC IMAGE SHOOTING AND DISPLAY QUALITY EVALUATION SYSTEM AND METHOD APPLICABLE THERETO

(71) Applicants: Fu-Jen Hsiao, Hsinchu City (TW); Wei-Jia Huang, Puli Township (TW); Chung-Wei Lin, Tainan City (TW)

(72) Inventors: Fu-Jen Hsiao, Hsinchu City (TW); Wei-Jia Huang, Puli Township (TW); Chung-Wei Lin, Tainan City (TW)

(73) Assignee: INDUSTRIAL TECHNOLOGY RESEARCH INSTITUTE, HSINCHU (TW)

(21) Appl. No.: 13/571,958

(22) Filed: Aug. 10, 2012

(30) Foreign Application Priority Data
Dec. 15, 2011 (TW) 100146652

(51) Int. Cl. H04N 13/02

(52) U.S. Cl. 348/46; 348/E13.074

(57) ABSTRACT

A stereoscopic image shooting system including an image shooting module and a score evaluation module is provided. The image shooting module is used for shooting a plurality of multi-view images of an object. The score evaluation module analyzes a plurality of stereoscopic images formed from the multi-view images to calculate a stereoscopic quality score of the stereoscopic images.

This application claims the benefit of Taiwan application Serial No. 100146652, filed Dec. 15, 2011, the disclosure of which is incorporated by reference herein in its entirety.

### TECHNICAL FIELD

The disclosure relates in general to a stereoscopic image shooting and playback quality evaluation system and a method applicable thereto.

### BACKGROUND

3D image (stereoscopic image) is widely used in many fields such as individuals, households, entertainment, business, medicine and education. Examples of 3D electronic consumer products include 3D liquid crystal display, 3D notebook/computer, 3D camera, 3D video recorder, 3D blue-ray player and even naked-eye 3D TV, and they are mainly related to audio/video applications.

Consumers concern not only price but also popularity of 3D content. Therefore, supply of 3D content is crucial to popularity of 3D products. Currently, 3D content may be produced in many ways: animation, actual shooting and 2D-to-3D conversion. Professional cameras having 3D photography functions are used in TV industry and movie industry.

In certain conventional 3D content making, a commissioner commissions a content producer to produce 3D image content of an object. At the early stage of production, the commissioner determines specification of the 3D display equipment (for example, naked-eye type 3D display or glasses type 3D display). The content producer shoots the stereoscopic images of the object and performs post production process. The content shooting and post production are performed at the content producer's workplace. Then, the content producer brings raw stereoscopic content to display on the commissioner's 3D display equipment for test. If the stereoscopic sense is not satisfactory, the content producer has to go back to their own workplace to do the shooting or calibration again. Such process may be repeated for a number of times, until stereoscopic sense of 3D content is satisfactory.

In producing the 3D content, the content producer may achieve higher 3D image quality if an excellent 3D shooting operation mechanism and an excellent 3D image quality evaluation mechanism are available.

The same 3D content played at different 3D display equipment may give different stereoscopic senses to different people. To the worse, the stereoscopic display (such as 3D naked-eye display equipment, theater display equipment, home TV, and so on) has a large volume of varieties and thus an objective evaluation structure is needed.

### SUMMARY

The disclosure is directed to a stereoscopic image shooting and playback quality evaluation system and a method applicable thereto. Process of shooting and synthesizing stereoscopic images at a shooting end is provided. The process works in conjunction with a stereoscopic image score evaluation system for evaluating and calculating a stereoscopic quality score of the stereoscopic image at a stereoscopic screen.

The disclosure is directed to a stereoscopic image shooting and playback quality evaluation system and a method applicable thereto. A plurality of multi-view images of an object is shot with a camera and a motion mechanism at the shooting end. Through analysis of feature information of multi-view stereoscopic image pairs, threshold disparity information of several stereoscopic image pairs is captured. An optimum disparity interval of the multi-view images is outputted and provided for the reference of stereoscopic special effect in post production. Furthermore, a stereoscopic quality score of the multi-view images is evaluated. If the score does not reach a predefined threshold, then the motion mechanism is adjusted and the multi-view images are shot again. Working in cooperation with the stereoscopic image playback quality evaluation system, the stereoscopic quality score of the stereoscopic images is tested at the stereoscopic screen to obtain objective data associated with calibration and test of stereoscopic sense.

According to one embodiment, a stereoscopic image shooting system including an image shooting module and a score evaluation module is provided. The image shooting module is used for shooting a plurality of multi-view images of an object. The score evaluation module is used for analyzing a plurality of stereoscopic images formed from the multi-view images to calculate a stereoscopic quality score of the stereoscopic images.

According to another embodiment, a stereoscopic quality evaluation system for evaluating a plurality of stereoscopic sensing factors of a 3D display is provided. The system includes an image shooting module and a score evaluation module. The image shooting module captures a plurality of multi-view images from a 3D display device. The score evaluation module analyzes the multi-view images to output a score of the 3D display device.

According to an alternative embodiment, a stereoscopic image shooting method is provided. A plurality of multi-view images of an object is shot. A score evaluation step is performed to analyze a plurality of stereoscopic images formed from the multi-view images and to calculate a stereoscopic quality score of the stereoscopic images.

According to another alternative embodiment, a stereoscopic quality evaluation method for evaluating a plurality of stereoscopic sensing factors of a 3D display is provided. A plurality of multi-view images is captured from a 3D display device. A score evaluation step is performed to analyze the multi-view images to output a score of the 3D display device.

The above and other contents of the disclosure will become better understood with regard to the following detailed description of the non-limiting embodiment (s). The following description is made with reference to the accompanying drawings.

### BRIEF DESCRIPTION OF THE DRAWINGS

FIG. 1 shows a schematic diagram of a stereoscopic image shooting system according to an embodiment of the disclosure;

FIG. 2 shows a flowchart of shooting a stereoscopic image according to the embodiment of the disclosure;

FIG. 3A shows an example of shooting multi-view images;

FIG. 3B shows pairing of the multi-view images of FIG. 3A;

FIG. 4 shows procedures of the optimum horizontal disparity analysis according to the embodiment of the disclosure;

FIG. 5A and 5B show flowcharts of obtaining critical horizontal disparity of the stereoscopic image pair according to the present embodiment of the disclosure;

FIG. 6 shows an example of feature points matching and noise feature points filtering according to the present embodiment of the disclosure;

FIG. 7 shows an example of a disparity histogram according to the embodiment of the disclosure;

FIG. 8A and FIG. 8B are two examples of cumulative disparity histogram according to the embodiment of the disclosure;

FIGS. 9A-9D are four scenarios showing the relationships between the optimum horizontal disparity interval and the tolerable disparity interval of the stereoscopic screen;

FIG. 10 shows a flowchart of vertical disparity analysis using feature-based matching according to the embodiment of the disclosure;

FIG. 11 shows flowchart of the stereoscopic window violation analysis according to the embodiment of the disclosure; and

FIG. 12 and FIG. 13 are two schematic diagrams of shooting adjustment according to the embodiment of the disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

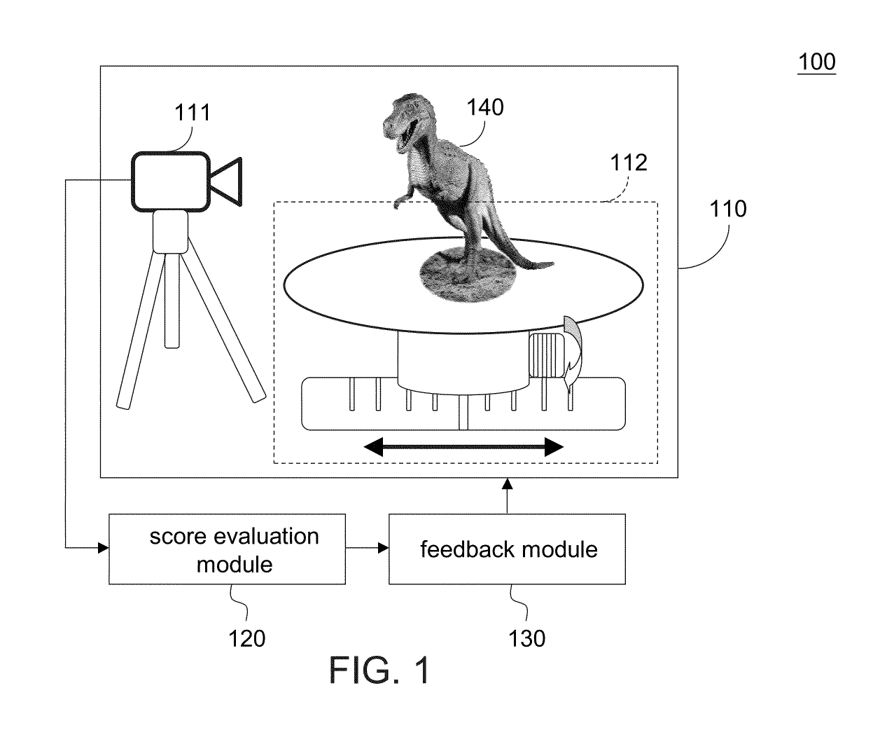

As indicated in FIG. 1, a schematic diagram of a stereoscopic image shooting system according to an embodiment of the disclosure is shown. The stereoscopic image shooting system 100 includes an image shooting module 110 and a score evaluation module 120. In addition, the system 100 of the present embodiment of the disclosure may include an optional feedback module 130.

The image shooting module 110 includes an image capturing unit 111 and a motion mechanism 112. The image capturing unit 111 shoots multi-view images of an object 140. The image capturing unit 111 is such as but not limited to a digital single-lens reflex camera. The motion mechanism 112 adjusts the relative position between the object 140 and the image capturing unit 111. The motion mechanism 112 may move and/or rotate the object 140. The control of the motion mechanism 112 is programmable. The motion mechanism 112 includes such as but not limited to, for example, a rotation disc and a slide rail. The slide rail moves the object 140 to change the relative distance between the object and the image capturing unit 111. The rotation disc rotates the object 140 to change the relative angle between the object and the image capturing unit 111. Further, in other possible embodiment of the application, the motion mechanism 112 may move and/or rotate the image capturing unit 111, which is still within the sprit of the application.

The score evaluation module 120 analyzes the stereoscopic images from the image shooting module 110 to calculate the stereoscopic quality score. The feedback module 130 feeds back the score to the image shooting module 110 to adjust the shooting parameter of the image shooting module 110. The score evaluation module 120 and the feedback module 130 are such as but not limited to a personal computer (PC).

The score evaluation module 120 may be performed on such as but not limited to a PC or a similar device. In the present embodiment of the disclosure, the score evaluation module 120 may include several quality score modules, such as an optimum horizontal disparity analysis module, a cross-talking analysis module, a vertical disparity analysis module and a stereoscopic window violation analysis module. In addition, the score evaluation module 120 may further include an overall score evaluation procedure.

In the present embodiment of the disclosure, a stereoscopic image playback quality evaluation system is provided. The stereoscopic image playback quality evaluation system is used in evaluating the quality of the produced stereoscopic images which plays in the scene, to help establishing the threshold for evaluation and test of 3D content.

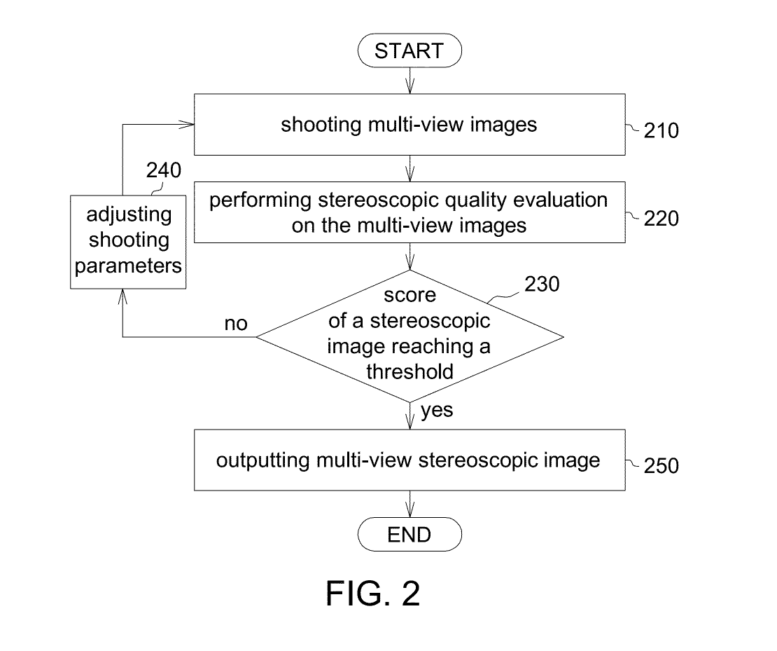

FIG. 2 shows a flowchart of shooting a stereoscopic image according to the embodiment of the disclosure. In step 210, multi-view images are shot by such as the image shooting module 110. In step 220, stereoscopic quality evaluation is performed on the multi-view images by such as the score evaluation module 120. In step 230, whether the score of the stereoscopic image reaches a threshold is evaluated by such as the score evaluation module 120. If the score reaches the threshold, then the stereoscopic image is outputted (step 250) and image production and image shooting may be performed based on the shooting parameters. Conversely, if the score does not reach the threshold, then the shooting parameters of the image shooting module 110 are adjusted as indicated in step 240. In step 240, the shooting parameters are adjusted by such as the feedback module 130.

Detailed descriptions of the embodiments of the disclosure are disclosed below.

### Shooting of Multi-View Images

The object 140 is placed on the rotation center of the motion mechanism 112. The motion mechanism 112 and the image capturing unit 111 may receive a control signal. The control signal is from such as but not limited to a PC (not illustrated). The image capturing unit 111 shoots the object 140 from different view-angles to capture a plurality of multi-view 2D images. There are two types of control signal transmitted to the motion mechanism 111, namely, a rotation signal and a movement signal. The rotation signal controls the angle of the motion mechanism 112 in a rotation. The movement signal controls the movement distance (forward or backward) of the motion mechanism 112 in a movement. The rotation signal and the movement signal provide parameters for calibrating the stereoscopic sense of stereoscopic images in subsequent processing.

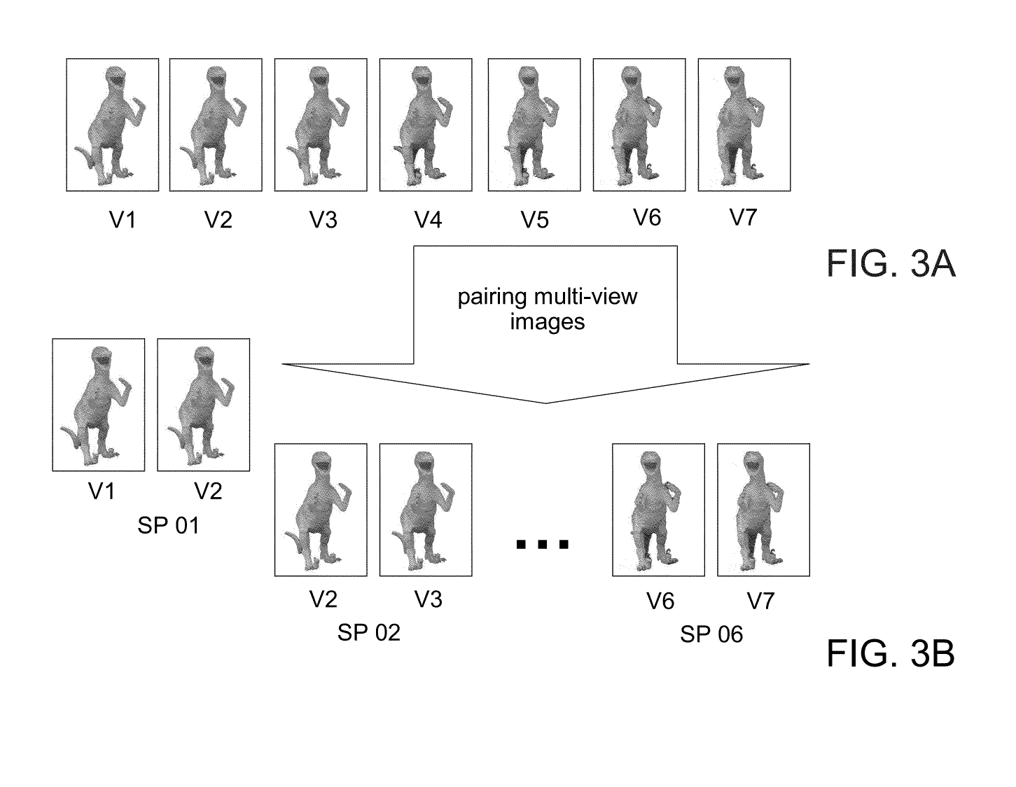

In the exemplification below, the desired multi-view image is formed from 7 different view-angles images. FIG. 3A shows an example of 7 multi-view images. Designations V1-V7 respectively denote 7 2D-images captured from 7 different view-angles. However, the number of the view-angles images here is merely an exemplification and is not for limiting the disclosure.

### Stereoscopic Quality Evaluation of Multi-view Images

In the present embodiment of the disclosure, the score evaluation module 120 respectively analyzes a plurality of quality indicators of the stereoscopic images according to such as an optimum horizontal disparity analysis, a vertical disparity analysis, a cross-talking analysis and a stereoscopic window violation analysis. The score evaluation module 120 may further perform an overall score evaluation procedure to calculate the sum of the scores of the stereoscopic images. Detailed descriptions of respective quality indicators are disclosed below.

### Optimum Horizontal Disparity Analysis

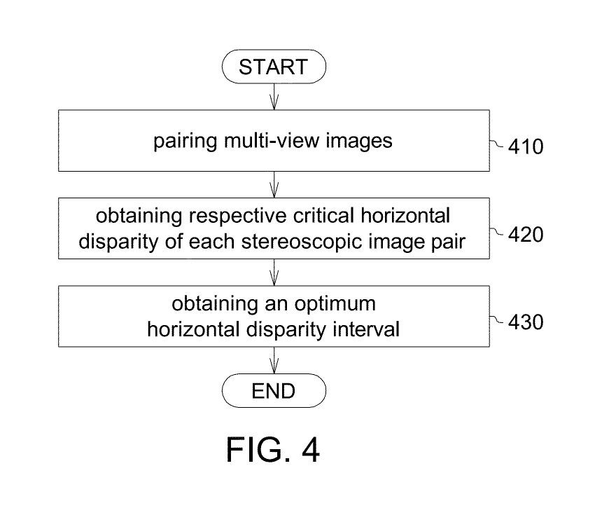

Optimum horizontal disparity analysis may be performed by the optimum horizontal disparity analysis module of the score evaluation module 120. According to the optimum horizontal disparity analysis, disparity range information of the multi-view images is analyzed, and an optimum disparity range and a horizontal disparity score of the stereoscopic images are outputted. Referring to FIG. 4, the optimum horizontal disparity analysis according to the embodiment of the disclosure is shown.

In step 410, the multi-view images are paired up into many stereoscopic image pairs. Referring to FIG. 3B, a pairing result of the multi-view images of FIG. 3A is shown. During analysis of the disparity information of the multi-view images, the multi-view images are paired into several stereoscopic image pairs each having two images. Each stereoscopic image pair includes a left eye image and a right eye image. In the example of the stereoscopic image with 7 view-angles, 7 original images V1-V7 are shot for the synthesis of images. The original images are paired up according to spatial relationship of the original images and display sequence of the original images in subsequent synthesis of the stereoscopic image. In the present embodiment of the disclosure, two neighboring images are paired up as a stereoscopic image pair. However, the present embodiment of the disclosure is not restricted by the above exemplification. The 7 original images V1-V7 are paired up as six stereoscopic image pairs SP01-SP06 as indicated in FIG. 3B. The stereoscopic image pair SP01 includes original images V1 and V2, and the remaining stereoscopic image pairs SP02-SP06 may be obtained similarly.

In other embodiments, if the display format of the naked-eye 3D display is N view-angles (N is a positive number larger or equal to 2), then the multi-view images are paired up as (N−1) stereoscopic image pairs. The embodiment of the application may be suitable to 2-view naked-eye display.

In step 420, respective threshold view-angles of the stereoscopic image pairs are obtained. In step 420, a part or whole of the disparity information of the stereoscopic image pairs is analyzed, and respective disparity threshold of the stereoscopic image pairs is calculated according to the disparity information.

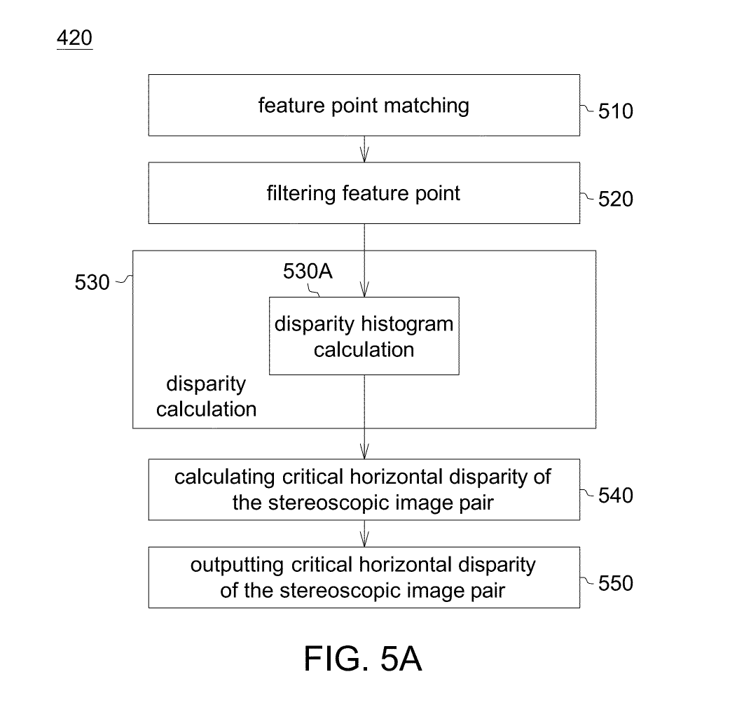

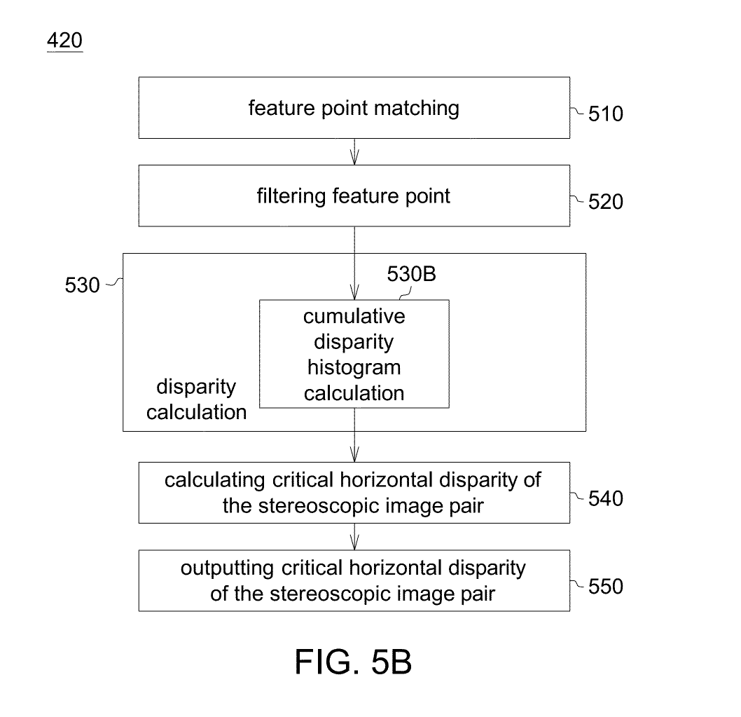

Details of step 420 are disclosed in FIG. 5A and/or FIG. 5B, which show flowcharts of obtaining disparity threshold of the stereoscopic image pair according to the present embodiment of the disclosure. In step 510, image feature points of the stereoscopic image pair are analyzed. The analysis of image feature points may be performed by a dense feature matching algorithm or a featured-based stereo matching algorithm. According to the featured-based stereo matching algorithm, the feature points of the left eye image and their coordinate information are located. The coordinate information of the feature points in the right eye image corresponding to the feature points in the left eye image is found. Let the stereoscopic image pair SP01 be taken for example. The left eye image is image V1, and the right eye image is image V2. According to the dense feature matching method, the corresponding feature points of the image pair are obtained by stereo matching.

After the coordinates (xₗ, yₗ) and (xᵣ, yᵣ) corresponding to the feature points of the left eye image and that of the right eye image are obtained, the disparity information is obtained accordingly. Here, the horizontal disparity dispₓ, the vertical disparity disp_{y} and the disparity absolute distance dis are respectively defined as:

dispₓxₗ−xᵣ;

disp_{y}=yₗ−yᵣ; and

dis=\sqrt{dispₓ²+disp_{y}²}.

(xₗ, yₗ) and (xᵣ, yᵣ) respectively denote the coordinate positions of the feature points in the left eye image and the right eye image. In the present embodiment of the disclosure, the feature point matching is a scale-invariant feature transform (SIFT) which reduces erroneous feature point matching due to rotation, size scale or brightness or contrast of images.

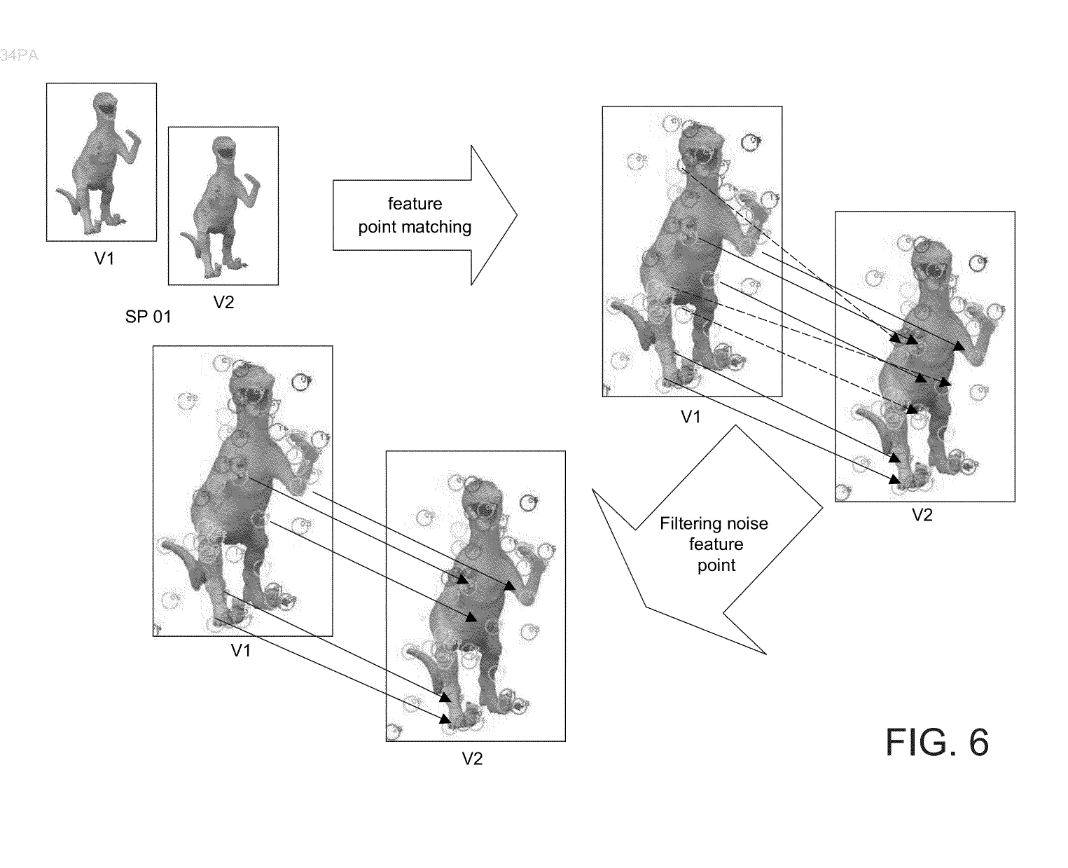

In step 520, the feature points are filtered off. The noise feature points may be occurred during matching of the feature points of the stereoscopic image pair. In the present embodiment of the disclosure, the following criteria are used for filtering off noise feature points: (1) the feature point having too large disparity absolute distance dis; (2) the feature point having too large vertical disparity disp_{y}; and (3) the feature point not matched to the epipolar geometry. FIG. 6 shows an example of matching of the feature points and filtering off of the noise feature points according to the present embodiment of the disclosure.

In step 530A (in FIG. 5A) or step 530B (in FIG. 5B), after erroneous feature points are filtered off, the disparity information (the dense disparity information obtained by the dense feature matching algorithm) of the entire frame or the disparity information (the featured-based disparity information obtained by the featured-based feature matching algorithm) of the object region is used for obtaining a statistical disparity diagram of the frame. In the present embodiment of the disclosure, the disparity calculation step 530 may include sub-step 530A or 530B or combination thereof.

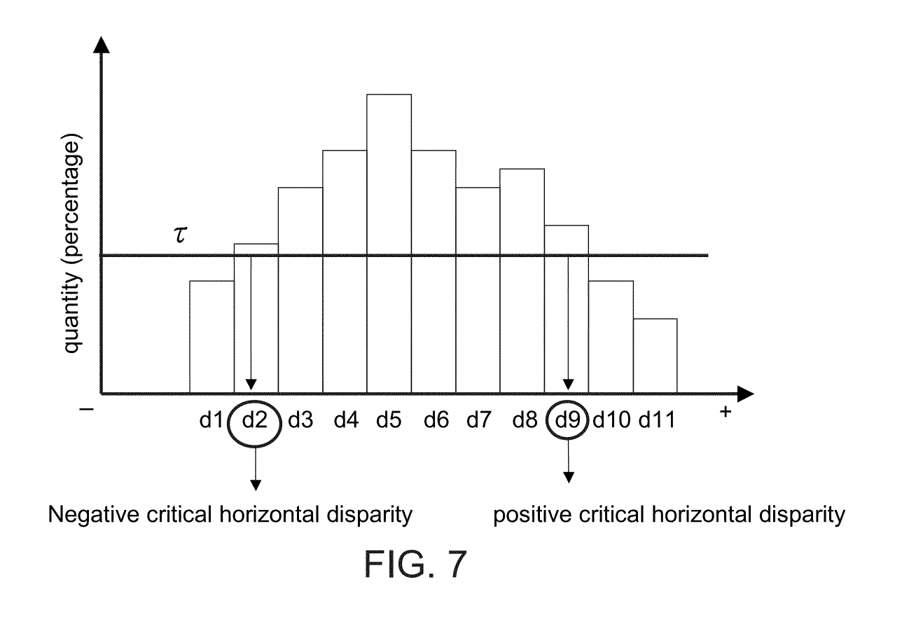

In sub-step 530A, a disparity histogram is calculated. The quantities or percentages of the disparities are calculated to form a histogram. In the histogram, the horizontal axis denotes the disparity, while the vertical axis denotes the pixel quantity or pixel percentages. FIG. 7 shows an example of a disparity histogram according to the embodiment of the disclosure, wherein d1˜d10 denote disparities.

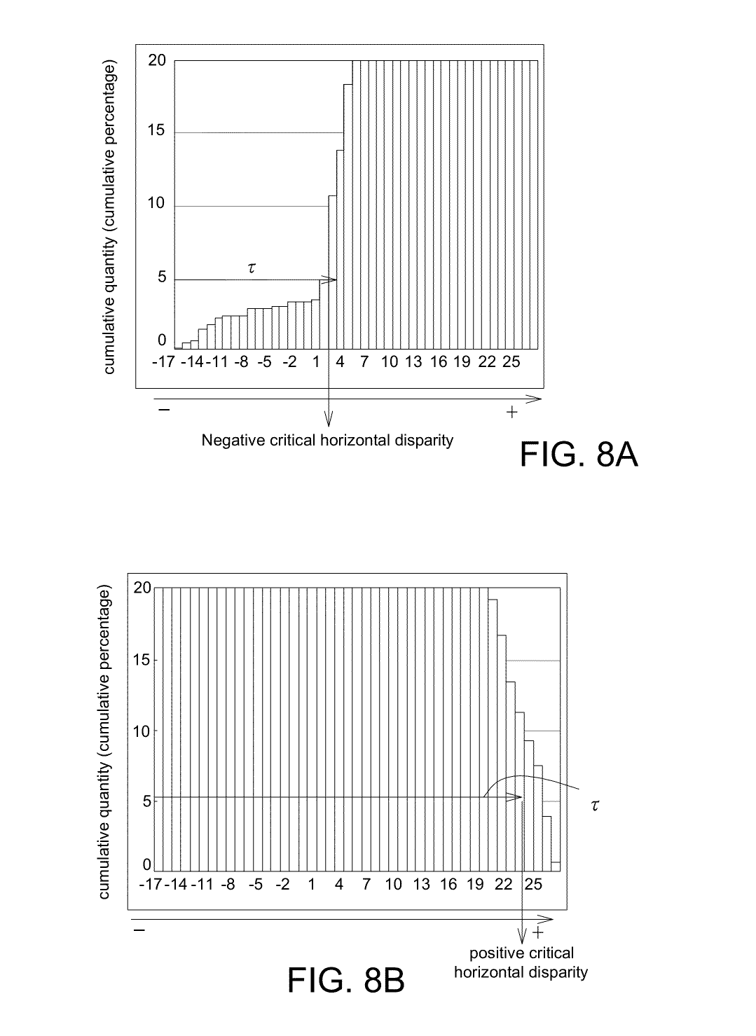

In sub-step 530B, a cumulative disparity histogram is calculated. The cumulative disparity histogram is obtained by cumulating the disparity histogram. The vertical axis denotes the cumulative pixel quantities or cumulative pixel percentages. FIG. 8A and FIG. 8B are two examples of cumulative disparity histogram according to the embodiment of the disclosure.

In step 540, disparity threshold of the stereoscopic image pair are calculated. After the disparity histogram or cumulative disparity histogram of the frame is obtained, disparity threshold of the stereoscopic image pair are determined according to the disparity histogram or the cumulative disparity histogram. A disparity threshold is defined as a disparity which gives uncomfortable stereoscopic sense to users in viewing the stereoscopic image pair. In other words, when the disparity for the stereoscopic image pair is larger than the disparity threshold, viewers will experience uncomfortable stereoscopic sense. The reason why the viewers may experience uncomfortable stereoscopic sense is either (1) too large negative disparity or (2) too large positive disparity. In a frame, if the percentage of pixels with intolerable negative disparity is too large, too many cross-talking regions will occur and make the viewer feel uncomfortable. Conversely, if the percentage of pixels with intolerable positive disparity is too large, the viewer will find it difficult to focus his/her eyes and therefore feels uncomfortable.

In the present embodiment of the disclosure, a smallest quality threshold is defined for locating disparity threshold of the stereoscopic image pair from the disparity histogram. When the percentage of pixels with intolerable negative disparity or the percentage of pixels with intolerable positive disparity is larger than the smallest quality threshold, the viewers would feel uncomfortable. The smallest quality threshold is normally determined according to the experience.

Let FIG. 7 be taken for example. Suppose the smallest quality threshold is τ (such as but not limited to 1%), the physical meaning is as follows: When the percentage of pixels with intolerable negative disparity or intolerable positive disparity is larger than τ (such as but not limited to 1%), the viewers would feel uncomfortable. The value of τ may be determined according to experience or actual needs.

In the present embodiment of the disclosure, the smallest quality threshold is located from the vertical axis of a disparity histogram. The disparities on the horizontal axis of the disparity histogram corresponding to the smallest quality threshold are determined as the negative disparity threshold and the positive disparity threshold (as indicated in FIG. 7). In the present embodiment of the disclosure, the stereoscopic image pair has its corresponding disparity histogram, the negative disparity threshold and the positive disparity threshold. In the present embodiment of the disclosure, a disparity threshold pair CDₙ={disp_{c-}, disp_{c+}}ₙ is obtained from the stereoscopic image pair, wherein disp_{c-} denotes the negative disparity threshold, disp_{c+} denotes the positive disparity threshold, and n denotes serial number of the stereoscopic image pairs.

In the present embodiment of the disclosure, the disparity threshold may be obtained from a cumulative disparity histogram. A smallest cumulative disparity threshold is obtained from the vertical axis of the cumulative disparity histogram. Then, the disparity on the horizontal axis of the cumulative disparity histogram corresponding to the smallest cumulative disparity threshold are determined as the negative disparity threshold and the positive disparity threshold (as indicated in FIG. 8A or FIG. 8B), and the corresponding disparities are used as the disparity threshold of the stereoscopic image pair CDₙ={disp_{c-}, disp_{c+}}ₙ.

Let FIG. 8A be taken for example. Suppose the smallest cumulative disparity threshold is τ, the physical meaning is as follows: When cumulative percentage of pixels with intolerable negative disparity is larger than τ, the viewers would feel uncomfortable. Similarly, let FIG. 8B be taken for example. Suppose the smallest cumulative disparity threshold is τ (such as but not limited to 2%), the physical meaning is as follows: When the cumulative percentage of pixels with intolerable positive disparity is larger than τ (such as but not limited to 2%), the viewers would feel uncomfortable. In step 550, disparity threshold of each stereoscopic image pair are outputted.

Again, referring to FIG. 4. In step 430, respective disparity threshold of each stereoscopic image pair are compared to obtain an optimum disparity interval of the stereoscopic image. The principles of comparison are as follows: The largest one of the positive disparity threshold of the stereoscopic image pairs is selected as the optimum positive disparity dispₒₚₜᵢ₊ in synthesizing the stereoscopic images. The smallest one of the negative disparity threshold of the stereoscopic image pairs is selected as the optimum negative disparity dispₒₚₜᵢ₋ in synthesizing the stereoscopic images. The optimum disparity interval dₒₚₜᵢ of the synthesized stereoscopic image is:

$${d}_{opti} = \{ {d}_{opti -} , {d}_{opti +} \} = \{ min ( {\{ {disp}_{c -} \}}_{1} , {\{ {disp}_{c -} \}}_{2} , {\{ {disp}_{c -} \}}_{3} , {\{ {disp}_{c -} \}}_{4} , {\{ {disp}_{c -} \}}_{5} , {\{ {disp}_{c -} \}}_{6} , {\{ {disp}_{c -} \}}_{7} ) , max ( {\{ {disp}_{c +} \}}_{1} , {\{ {disp}_{c +} \}}_{2} , {\{ {disp}_{c +} \}}_{3} , {\{ {disp}_{c +} \}}_{4} , {\{ {disp}_{c +} \}}_{5} , {\{ {disp}_{c +} \}}_{6} , {\{ {disp}_{c +} \}}_{7} ) \}$$

The optimum disparity dₒₚₜᵢ is used as a basis for the subsequent stereoscopic image post production procedure, or calibration and testing of the stereoscopic sense.

### Calculation of Optimum Horizontal Disparity Score

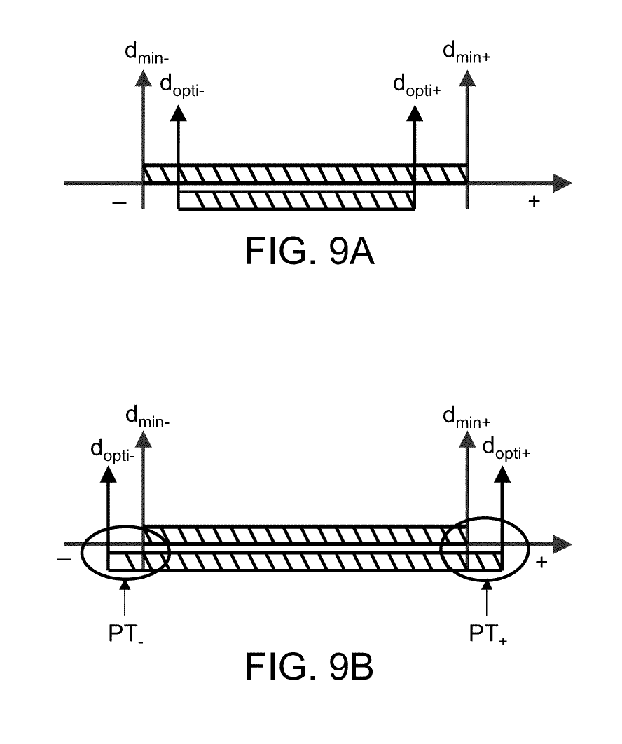

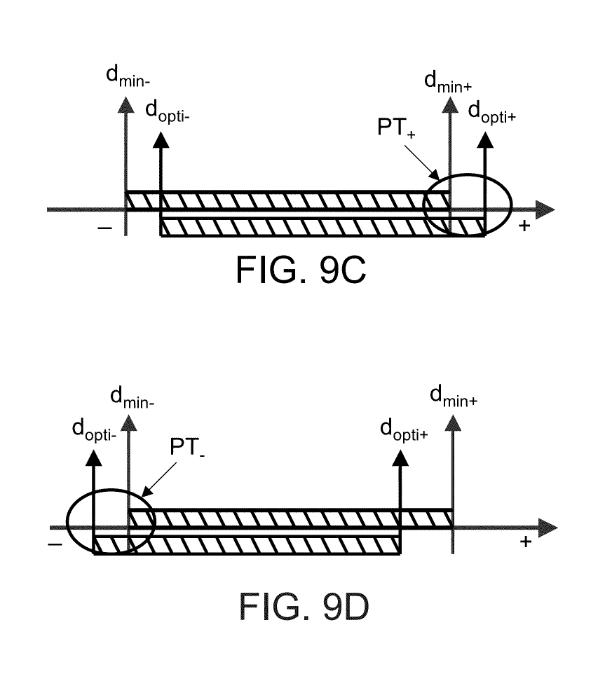

After the optimum disparity dₒₚₜᵢ is obtained, the score of the optimum horizontal disparity indicator of the stereoscopic image may be calculated. Details are as follows. A comparison between the optimum horizontal disparity interval and a screen tolerable disparity interval is performed, and the scores are outputted according to four scenarios elaborated below. Referring to FIGS. 9A-9D, four scenarios showing the relationships between the optimum horizontal disparity interval and the screen tolerable disparity interval are respectively shown.

As indicated in FIG. 9A, the display optimum horizontal disparity falls within the screen tolerable disparity interval. The quality score is calculated according to the following mechanism:

$$score = \frac{{d}_{opti}}{{d}_{screen}} = \frac{\vert {d}_{opti -} - {d}_{opti +} \vert}{\vert {d}_{min -} - {d}_{min +} \vert}$$

Wherein d_{screen} denotes a screen tolerable disparity interval, dₘᵢₙ₋ and dₘᵢₙ₊ respectively denote a screen negative disparity upper limit and a screen positive disparity upper limit, and dₒₚₜᵢ denotes an optimum horizontal disparity interval.

As indicated in FIG. 9B, the display optimum horizontal disparity falls outside the screen tolerable disparity interval. The quality score is calculated according to the following mechanism:

$$score = \frac{{d}_{opti} - penalty {term}_{-} - penalty {term}_{+}}{{d}_{screen}} = \frac{\begin{matrix}\vert {d}_{opti -} - {d}_{opti +} \vert - w ( \vert {d}_{opti -} - {d}_{min -} \vert ) * \\ \vert {d}_{opti -} - {d}_{min -} \vert - w ( \vert {d}_{opti +} - {d}_{min +} \vert ) * \vert {d}_{opti +} - {d}_{min +} \vert\end{matrix}}{\vert {d}_{min -} - {d}_{min +} \vert}$$

Wherein penaltyterm₋ denotes a penalty (“PT₋” as indicated in FIG. 9B) because the display optimum horizontal disparity is outside the screen negative disparity upper limit, and penaltyterm₊ denotes a penalty (“PT₊” as indicated in FIG. 9B) because the display optimum horizontal disparity is outside the screen positive disparity upper limit. The penalty item is related to how far a disparity falls outside the limit and is described by the function w(|dₒₚₜᵢ₋−dₘᵢₙ₋|) or w(|dₒₚₜᵢ₊−dₘᵢₙ₊|).

As indicated in FIG. 9C, the optimum positive disparity is larger than the screen positive disparity upper limit, and the optimum negative disparity is larger than the screen negative disparity upper limit. The quality score is calculated according to the following mechanism:

$$score = \frac{{d}_{opti} - penalty {term}_{+}}{{d}_{screen}} = \frac{\vert {d}_{opti -} - {d}_{opti +} \vert - w ( \vert {d}_{opti +} - {d}_{min +} \vert ) * \vert {d}_{opti +} - {d}_{min +} \vert}{\vert {d}_{min -} - {d}_{min +} \vert}$$

As indicated in FIG. 9D, the optimum positive disparity is smaller than the screen positive disparity upper limit, and the optimum negative disparity is smaller than the screen negative disparity upper limit. The quality score is calculated according to the following mechanism:

$$score = \frac{{d}_{opti} - penalty {term}_{-}}{{d}_{screen}} = \frac{\vert {d}_{opti -} - {d}_{opti +} \vert - w ( \vert {d}_{opti -} - {d}_{min -} \vert ) * \vert {d}_{opti -} - {d}_{min -} \vert}{\vert {d}_{min -} - {d}_{min +} \vert}$$

A comparison between the optimum horizontal disparity interval and the screen tolerable disparity interval is made, and the scores are normalized as 0˜100. The formula in the present embodiment of the disclosure is: ScoreHD=100·score, wherein ScoreHD denotes a normalized optimum horizontal disparity score. The above description shows that the closer to the screen tolerable disparity interval the optimum horizontal disparity interval is, the higher the score ScoreHD will be.

### Analysis of Vertical Disparity

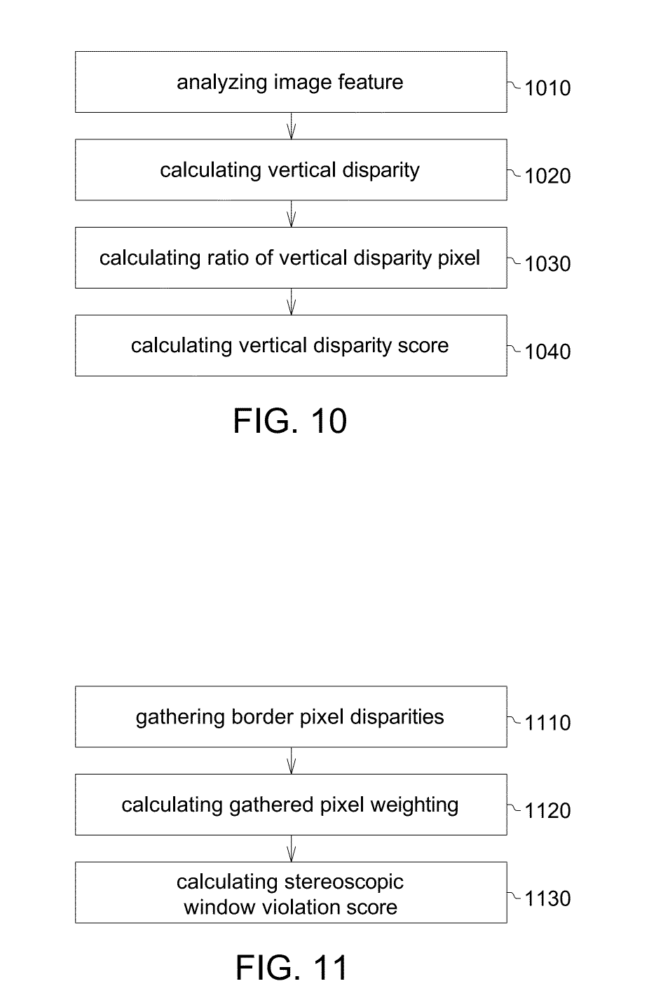

The vertical disparity analysis is performed by the vertical disparity analysis module of the score evaluation module 120. If the vertical disparity is too large, the viewers would feel uncomfortable when watching stereoscopic images. In the present embodiment of the disclosure, the vertical disparity analysis may use the dense feature matching algorithm or the feature-based feature matching algorithm. The dense feature matching algorithm may use an optical flow algorithm or a block based motion estimation algorithm to calculate corresponding pixels of the same image pair. The feature-based feature matching algorithm may be implemented by a feature point describer such as an SIFT algorithm or an SURF algorithm. FIG. 10 shows a flowchart of vertical disparity analysis based on feature-based feature matching according to the embodiment of the disclosure.

In step 1010, image feature analysis is performed. Feature points are obtained from the stereoscopic image pair; and correspondence between the feature points is analyzed. Two feature points corresponding to each other are referred as a feature point pair. The feature point pairs are processed according to the SIFT algorithm and the filtering criteria into robust and reasonable feature point pairs.

In step 1020, the vertical disparity is calculated. For the feature point pair obtained in step 1010, a vertical difference on the coordinate position of the feature point pair is calculated and defined as a vertical disparity. The vertical difference is a difference between vertical coordinates of two feature points of a feature point pair. For example, suppose the coordinates of the two points p1 and p2 of a feature point pair are (x1, y1) and (x2, y2) respectively, the vertical difference for points p1 and p2 is expressed as: VD (p1, p2)=abs (y1−y2).

In step 1030, the ratio of vertical disparity pixel is calculated. The ratio of the number of feature point pairs with intolerable vertical disparity (that is, the vertical disparity is large than a vertical disparity threshold) to the number of total feature point pairs is calculated according to the following formula:

$${P}_{vDisp} = \frac{1}{nm} {\sum }_{v = 1}^{m} {\sum }_{i = 1}^{n} f ( VD ( {p}_{vi 1} , {p}_{vi 2} ) > {th}_{vDisp} )$$

Wherein, n denotes the total number of feature point pairs; m denotes the total number of the stereoscopic image pairs, pᵥᵢ₁, pᵥᵢ₂ are two corresponding points of the i-th feature point pair of the v-th stereoscopic image pair; th_{vDisp} denotes a pre-defined threshold; f( ) denotes a determination function, if the condition of function of f( ) holds true, then f( ) is equal to 1, otherwise f( ) is equal to 0.

In step 1040, vertical disparity score is calculated. The above ratio of pixels with intolerable vertical disparity is normalized into scores 0˜100 according to the following formula: ScoreVD=100·(1−P_{vDisp}). The larger the number of feature point pairs with intolerable vertical disparity is, the lower the score will be.

### Analysis of the Stereoscopic Window Violation

The stereoscopic window violation (SWV) indicates intolerable negative disparity occurring at image borders, which causes uncomfortable stereoscopic sense to the viewers. Analysis of the stereoscopic window violation may be implemented by the stereoscopic window violation analysis module of the score evaluation module 120. The analysis of the stereoscopic window violation takes the horizontal disparities of the stereoscopic image pairs as inputs and gathers statistics at the image borders. The procedures of the analysis of the stereoscopic window violation are indicated in FIG. 11.

In step 1110, border pixel disparities are gathered. The term “border pixel” refers to pixels within a set of predefined blocks nearby the image borders. The border pixel (x, y) with negative disparity is collected and each one has a penalty contribution according to the following formula:

$${V}_{Neg} ( x , y ) = min ( 1 , \frac{abs ( {Disp}^{-} ( x , y ) )}{{Disp}_{Max}^{-}} ) .$$

Where Disp⁻(x, y) indicates the negative disparity of border pixel (x, y). Disp⁻_{Max} is a predefined constant. The set of border pixels with negative disparity is represented as Ω. The pixel points with positive disparities are not considered.

In step 1120, the weighting of each border pixel are calculated. The influence of a gathered border pixel from previous step is obtained by multiplying its penalty contribution with a weighting function f(x,y), and is expressed as P_{SWV}(x,y)=f(x,y)*V_{Neg}(x,y). In the present embodiment of the disclosure, f(x,y) is an inverse proportion of the shortest distance d from the border pixel (x, y) to the border and is expressed as: f(x,y)=1/d. The above formula shows that the pixels farther away from the border have smaller weight to the stereoscopic window violation.

In step 1130, stereoscopic window violation scores are calculated. The score is expressed as:

$${Score}_{SWV} = 100 \cdot ( 1 - \frac{{\sum }_{Ω} {P}_{SWV} ( x , y )}{{N}_{border}} )$$

N_{border} is the number of border pixels.

### Determination of Stereoscopic Image Quality Score

After the analysis of stereoscopic image quality is completed, the scores of respective procedures are inputted to the overall score estimation procedure. Then, the overall score estimation procedure obtains an overall score of the stereoscopic image according to the optimum horizontal disparity score, the vertical disparity score, and the stereoscopic window violation score. The overall score estimation procedure performs weighting summation on the above scores to obtain an overall score of the stereoscopic image quality. If one of the quality indicator scores does not exist, the weight w of the quality indicator is set to 0. The calculation of weighting summation is expressed as: Scoreₛᵤₘ=w₁ScoreVD+w₂ScoreSWV+w₃ScoreHD Wherein, w₁˜w₃ respectively denote the weights, and w₁+w₂+w₃=1.

The overall score Scoreₛᵤₘ is compared with a pre-determined quality score threshold thrd_{quality}. If the overall score is smaller than the quality score threshold, then the shooting angle or/and the shooting distance is adjusted; otherwise the stereoscopic image is outputted.

In the present embodiment of the disclosure, details of the adjustment of the shooting parameter (step 240) are disclosed below. Here, the shooting parameter includes such as a shooting distance and/or a shooting angle.

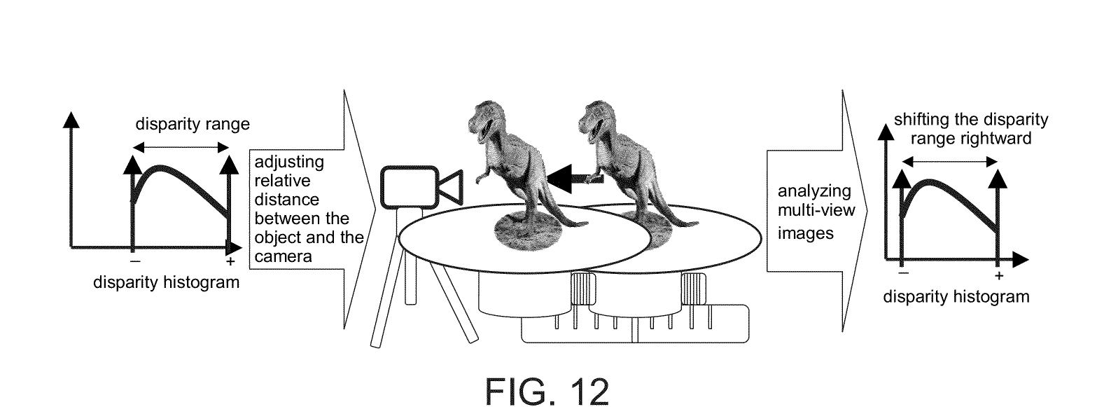

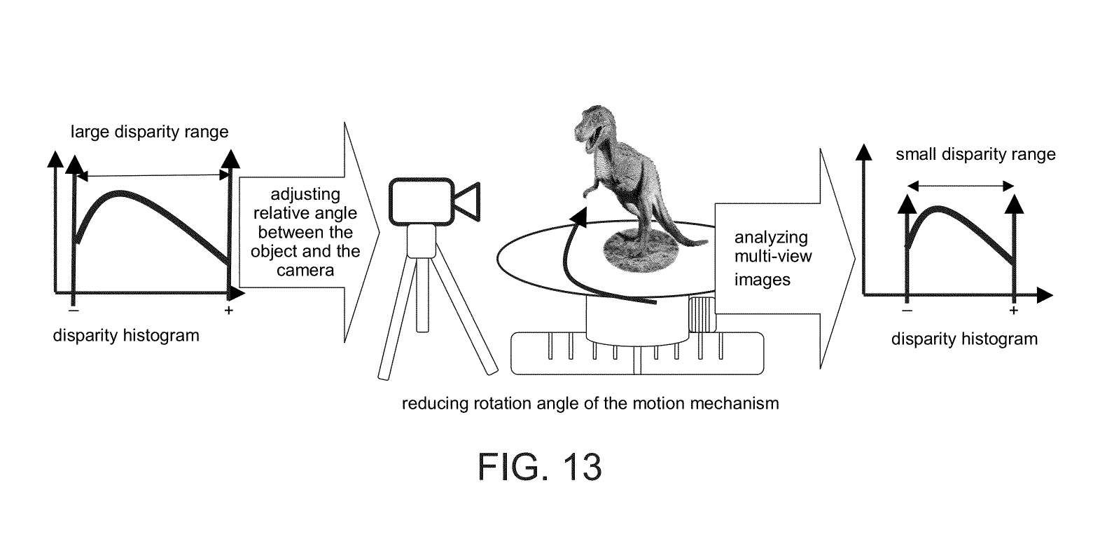

Referring to FIG. 12 and FIG. 13, two schematic diagrams of shooting adjustment according to an embodiment of the disclosure are shown. As indicated in FIG. 12, if the optimum disparity interval of the stereoscopic image is too close to the zero plane, this implies that the stereoscopic sense of the stereoscopic image is inadequate. Then, the motion mechanism 112 is adjusted to move the object 140 closer to the image capturing unit 111 and a plurality of multi-view images is captured again. By doing so, an optimum disparity interval providing better stereoscopic sense may be obtained (because the disparity range is shifted rightwards). Conversely, if the optimum disparity interval of the stereoscopic image is too far away from the zero plane, this implies that the stereoscopic sense of the stereoscopic image is too strong. Then, the motion mechanism 112 is adjusted to move the object 140 farther away from the image capturing unit 111, and a plurality of multi-view images is captured again. By doing so, an optimum disparity interval providing better stereoscopic sense may be obtained (because the disparity range is shifted leftwards).

Referring to FIG. 13. If the optimum disparity interval of the stereoscopic image is too large, this implies that the remaining disparity space for special effect in post production on the stereoscopic image may be not enough. Then, the motion mechanism 112 is adjusted to reduce the rotation angle of the motion mechanism 112 in a rotation, and a plurality of multi-view images is captured again. By doing so, an optimum disparity interval with a reduced range of disparity may be obtained. Conversely, if the optimum disparity interval of the stereoscopic image is too small, the motion mechanism 112 is adjusted to enlarge the rotation angle of the motion mechanism 112 in a rotation, and a plurality of multi-view images is captured again. By doing so, an optimum disparity interval with an enlarged range of disparity may be obtained.

The present embodiment of the disclosure also discloses a stereoscopic image playback quality evaluation system for testing the quality of a stereoscopic image displayed on a stereoscopic display. The quality evaluation system may use one or multiple image capturing units for capturing the stereoscopic images. The positions and directions of the image capturing units are determined according to the desired view-angles. Therefore, the stereoscopic image playback quality evaluation system may not include a motion mechanism and a feedback module if there is no need to move the object 140. During testing, a comfort region for the viewer is set. The setting of the comfort region may be determined according to the display environment, such as the distance to the user, the tolerable positive/negative disparity, the tolerable high contrast range and so on. The quality evaluation analysis performed on the captured images mainly analyzes quality factors such as disparity distribution, high contrast, vertical disparity, stereoscopic window violation and so on. These items are summarized and evaluated to obtain scores, and the result of analysis is reported.

For example, in the present embodiment of the disclosure, one camera is used and a 7-view-angle stereoscopic display is used as the testing environment. The camera is erected at the i-th view-angle (0<i≦7) of the stereoscopic display. An i-th view-angle frame, an (i+1)-th view-angle frame and a complete stereoscopic frame image are sequentially displayed and captured. Stereo matching is performed on the i-th view-angle frame and the (i+1)-th view-angle frame for calculating the horizontal disparity and the vertical disparity, and the obtained horizontal disparity is used for calculating the stereoscopic window violation. In addition, in capturing the i-th view-angle frame, a system controls the display to play only the i-th view-angle frame to extract an image “I”; and the system controls the display to play all view-angle images for the system to extract an image “J”. Cross-talking image may be obtained by calculating a color difference between the image “I” and the image “J”. The system summarizes the image analysis scores and then produces a score for the stereoscopic image. The score of the stereoscopic image playback quality is evaluated according to the following criteria.

(1) Vertical disparity score Score_{VD}: The vertical disparity is obtained by performing stereo matching on the i-th view-angle frame and the (i+1)-th view-angle frame. The larger the vertical disparity is, the lower the score is. The details for obtaining the vertical disparity score Score_{VD} are identical or similar to that for obtaining the abovementioned vertical view-angle score, and are not repeated here.

(2) Stereoscopic window violation score Score_{SWV}: Based on the distribution of the horizontal disparity of pixels around the image borders, the stereoscopic window violation will occur if the pixels around the image borders have intolerable negative disparity. The more the stereoscopic window violation occurs, the lower the score will be. The details for obtaining stereoscopic window violation score item Score_{SWV} are identical or similar to that for obtaining the abovementioned stereoscopic window violation score, and are not repeated here.

(3) Cross-talking score item Score_{CT}: The color difference between images “I” and “J” denotes influence degree by optical factors when the viewer views images. The larger the difference, the lower the cross-talking score. The calculation of Score_{CT} is expressed as:

$${Score}_{CT} = \frac{100}{N} {\sum }_{x} {\sum }_{y} \frac{MaxDiff - abs ( I ( x , y ) - J ( x , y ) )}{MaxDiff}$$

Wherein N denotes the total number of pixels of an image; MaxDiff denotes a upper bound value of color difference between two pixels; I (x, y) and J (x, y) are pixels (x, y) of image I and image J, respectively; abs( ) denotes an absolute value function.

(4) Optimum horizontal disparity score Score_{HD}: The optimum horizontal disparity interval of a stereoscopic image is obtained through disparity threshold analysis and is compared with a screen tolerable disparity interval. The more overlap between the disparity interval and the optimum horizontal disparity interval, the larger the optimum horizontal disparity score will be. The details for obtaining the optimum horizontal disparity score Score_{HD} are identical or similar to the abovementioned optimum horizontal disparity score, and are not repeated here.

The abovementioned scores are weighted to produce a playback quality score. The calculation of the playback quality score is expressed as: S=w₁ScoreVD+w₂ScoreSWV+w₃ScoreCT+w₄ScoreHD. Wherein, w₁˜w₄ respectively denote the weights, and w₁+w₂+w₃+w₄=1.

According to the stereoscopic image shooting and playback quality evaluation system and the method applicable thereto of the embodiments of the disclosure, a camera and a motion mechanism are erected at the shooting end. A plurality of multi-view images of an object is shot with the camera and the motion mechanism. The feature information of stereoscopic image pairs of multi-view images is analyzed to obtain disparity threshold of the stereoscopic image pairs. An optimum disparity interval of the multi-view images is obtained and used as a reference in stereoscopic special effect in post production. The stereoscopic quality score of the multi-view images is evaluated. If the score is not satisfied, then the motion mechanism is adjusted and a plurality of multi-view images with better/adjusted stereoscopic effect is shot again. The shooting system is used in conjunction with the stereoscopic image playback quality evaluation system. At the stereoscopic screen, a stereoscopic quality score of the stereoscopic image is calculated and used in calibration and testing of stereoscopic sense to assure that the stereoscopic sense of stereoscopic image is conformed to the threshold in the pre-production. The present embodiment of the disclosure effectively connects content production and content display, considers both quality and cost in the production of stereoscopic image and reduces the manufacturing cost of stereoscopic content.

As disclosed above, the embodiments of the disclosure resolve the problems of complexity and expensive cost in the production of 3D content. The shooting system of the disclosure produces stereoscopic image content with high quality, and resolves the problem of poor stereoscopic effect of 3D content for the 3D content manufacturer. The shooting system works well both in quality and cost, effectively reduces the manufacturing cost of stereoscopic content, and is applicable to digital content manufacturers, advertisement manufacturers and/or multimedia manufacturers, and particularly to 3D image production manufacturers. The above embodiments of the disclosure are also applicable to 3D application, such as 3D TV, 3D digital signage, naked-eye 3D smart phone, naked-eye 3D tablet PC and so on.

In addition, in the present disclosure, the modules (for example, the score evaluation module or the feedback module) are implemented by a computer, but the disclosure is not limited thereby. The modules may be also implemented by a processor, a digital signal processor, a digital video processor, or a programmable integrated circuit such as a microcontroller and a field programmable gate array (FPGA), which is designed with such as hardware description language (HDL).

Furthermore, the above methods of the present disclosure may also be implemented by software programs or program codes. For example, program codes or software programs of an example of the present disclosure may be recorded in a recoding medium such as an ROM, an RAM, and other media of the like, an optical recoding medium, a magnetic recoding medium or other recording media. Furthermore, the program code may also be implemented by firmware. A processing unit may implement the method of the examples of the present disclosure upon reading the program codes implementing the present disclosure from a recoding media and then execute the program code accordingly. Furthermore, the above methods of the examples of the present disclosure may be implemented by a combination of software and hardware.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A stereoscopic image shooting system, comprising:
an image shooting module used for shooting a plurality of multi-view images of an object; and
a score evaluation module used for analyzing a plurality of stereoscopic images formed from the plurality of multi-view images to calculate a stereoscopic quality score of the plurality of stereoscopic images.

2. The stereoscopic image shooting system according to claim 1, comprising:
a feedback module used for controlling the image shooting module to adjust shooting parameters of the image shooting module according to the stereoscopic quality score.

3. The stereoscopic image shooting system according to claim 1, wherein the image shooting module comprises:
at least one image capture unit used for capturing the plurality of multi-view images of the object; and
at least one motion mechanism used for changing a relative distance relationship and/or a relative angle relationship between the object and the at least one image capture unit.

4. The stereoscopic image shooting system according to claim 1, wherein the score evaluation module analyzes an optimum horizontal disparity score of the plurality of stereoscopic images of the object.

5. The stereoscopic image shooting system according to claim 1, wherein the score evaluation module analyzes a vertical disparity score of the plurality of stereoscopic images of the object.

6. The stereoscopic image shooting system according to claim 1, wherein the score evaluation module analyzes a stereoscopic window violation score of the plurality of stereoscopic images of the object.

7. The stereoscopic image shooting system according to claim 1, wherein:
the score evaluation module analyzes at least any one of an optimum horizontal disparity score, a vertical disparity score and a stereoscopic window violation score of the plurality of stereoscopic images of the object or any combination thereof, and
the score evaluation module summarizes the optimum horizontal disparity score and/or the vertical disparity score and/or the stereoscopic window violation score as a final score.

8. The stereoscopic image shooting system according to claim 5, wherein when the score evaluation module analyzes the vertical disparity score,
the score evaluation module locates and filters a plurality of feature point matches of a stereoscopic image pair, wherein the stereoscopic image pair is a combination of the plurality of multi-view images;
the score evaluation module calculates respective vertical disparity of each feature point match of the stereoscopic image pair;
the score evaluation module calculates a ratio of high vertical disparity feature point matches of the stereoscopic image pair to total feature point matches of the stereoscopic image pair, wherein a high vertical disparity feature point match is defined as the feature point match having a vertical disparity larger than a vertical disparity threshold; and
the score evaluation module sums respective vertical disparity quantitative indicator of each stereoscopic image pair, and outputs the vertical disparity score according to the sum.

9. The stereoscopic image shooting system according to claim 6, wherein when the score evaluation module analyzes the stereoscopic window violation score,
the score evaluation module evaluates the stereoscopic window violation score based on a plurality of negative disparity pixels of a stereoscopic image pair within a range distant from an image border and absolute values of negative disparities of the plurality of negative disparity pixels, wherein the stereoscopic image pair is selected from the plurality of multi-view images;
the score evaluation module calculates respective stereoscopic window violation score of each negative disparity pixel, wherein the stereoscopic window violation score is associated with the absolute values of the negative disparities of the plurality of negative disparity pixels and a weight function related to a distance from one of the plurality of negative disparity pixels to the image border.

10. The stereoscopic image shooting system according to claim 7, wherein when the score evaluation module analyzes the optimum horizontal disparity score,
the score evaluation module pairs up the plurality of multi-view images into a plurality of stereoscopic image pairs;
the score evaluation module obtains respective critical horizontal disparity of the stereoscopic image pairs;
the score evaluation module compares the respective critical horizontal disparity of the stereoscopic image pairs to calculate an optimum horizontal disparity interval; and
the score evaluation module compares the optimum horizontal disparity interval with a tolerable disparity interval of a stereoscopic screen to obtain the optimum horizontal disparity score.

11. The stereoscopic image shooting system according to claim 10, wherein when the score evaluation module obtains the respective critical horizontal disparity of the stereoscopic image pairs,
the score evaluation module analyzes and filters image features of the stereoscopic image pair;
the score evaluation module obtains a statistic information of disparities of the stereoscopic image pair according to the image features of the stereoscopic image pair; and
the score evaluation module determines the corresponding critical horizontal disparity of the stereoscopic image pair according to the statistic information of disparities, wherein the critical horizontal disparity comprises a critical positive disparity and a critical negative disparity.

12. The stereoscopic image shooting system according to claim 11, wherein when the score evaluation module compares the respective critical horizontal disparity of the stereoscopic image pairs to calculate the optimum horizontal disparity interval,
the score evaluation module selects a maximum from the critical positive disparities of the critical horizontal disparity of the stereoscopic image pairs and selects a minimum from the critical negative disparities of the critical horizontal disparity of the stereoscopic image pairs to form the optimum horizontal disparity interval.

13. The stereoscopic image shooting system according to claim 11, wherein
the score evaluation module analyzes the image features of the stereoscopic image pair according to a dense feature matching or a feature-based matching; and
the score evaluation module filters the image features of the stereoscopic image pair according to a disparity absolute distance parameter, a vertical disparity parameter and an epipolar geometry parameter.

14. A stereoscopic quality evaluation system for evaluating a plurality of stereoscopic sensing factors of a 3D display, the stereoscopic quality evaluation system comprising:
an image shooting module used for capturing a plurality of multi-view images from a 3D display device; and
a score evaluation module used for analyzing stereoscopic images of the plurality of multi-view images to output a score of the 3D display device.

15. The stereoscopic quality evaluation system according to claim 14, wherein the score evaluation module analyzes a optimum horizontal disparity score, or a vertical disparity score, or a stereoscopic window violation score, or a cross-talking score, or an overall score of the plurality of multi-view images, or any combination thereof.

16. The stereoscopic quality evaluation system according to claim 15, wherein when the score evaluation module analyzes the vertical disparity score,
the score evaluation module locates and filters a plurality of corresponding feature point matches of a stereoscopic image pair, wherein the stereoscopic image pair is selected from the plurality of multi-view images;
the score evaluation module calculates respective vertical disparity of each feature point match of the stereoscopic image pair;
the score evaluation module calculates a ratio of high vertical disparity feature point matches of the stereoscopic image pair to total feature point matches of the stereoscopic image pair, wherein a high vertical disparity feature point match is defined as the feature point match having a vertical disparity larger than a vertical disparity threshold; and
the score evaluation module sums respective vertical disparity quantitative indicator of each stereoscopic image pair and outputs the vertical disparity score according to the sum.

17. The stereoscopic quality evaluation system according to claim 15, wherein when the score evaluation module analyzes the stereoscopic window violation score,
the score evaluation module evaluates the stereoscopic window violation score based on to a plurality of negative disparity pixels of a stereoscopic image pair within a range distant from an image border and absolute values of negative disparities of the plurality of negative disparity pixels, wherein the stereoscopic image pair is selected from the plurality of multi-view images;
the score evaluation module calculates respective stereoscopic window violation score of each negative disparity pixel, wherein the stereoscopic window violation score is associated with the absolute values of the negative disparities of the plurality of negative disparity pixels and a weight function related to a distance from one of the plurality of negative disparity pixels to the image border.

18. The stereoscopic quality evaluation system according to claim 15, wherein when the score evaluation module calculates the cross-talking score,
the score evaluation module calculates a corresponding region of a stereoscopic image pair, wherein the stereoscopic image pair is selected from the plurality of multi-view images;
the score evaluation module calculates color difference of the corresponding region of the stereoscopic image pair to estimate a cross-talking quantitative indicator; and
the score evaluation module calculates a sum of all cross-talking quantitative indicators of the stereoscopic image pairs to output the cross-talking score.

19. The stereoscopic quality evaluation system according to claim 15, wherein when the score evaluation module analyzes the optimum horizontal disparity score,
the score evaluation module pairs up the plurality of multi-view images into a plurality of stereoscopic image pairs;
the score evaluation module obtains respective critical horizontal disparity of the stereoscopic image pairs;
the score evaluation module compares the respective critical horizontal disparity of the stereoscopic image pairs to calculate an optimum horizontal disparity interval; and
the score evaluation module compares the optimum horizontal disparity interval with a tolerable disparity interval of a stereoscopic screen to obtain the optimum horizontal disparity score.

20. The stereoscopic quality evaluation system according to claim 19, wherein when the score evaluation module obtains the respective critical horizontal disparity of the stereoscopic image pairs,
the score evaluation module analyzes and filters image features of the stereoscopic image pair;
the score evaluation module obtains a statistic information of disparities of the stereoscopic image pair according to the image features of the stereoscopic image pair; and
the score evaluation module determines the corresponding critical horizontal disparity of the stereoscopic image pair according to the statistic information of disparities, wherein the critical horizontal disparity comprises a critical positive disparity and a critical negative disparity.

21. The stereoscopic quality evaluation system according to claim 19, wherein when the score evaluation module compares the respective critical horizontal disparity of the stereoscopic image pairs to calculate an optimum horizontal disparity interval,
the score evaluation module selects a maximum from the critical positive disparities of the critical horizontal disparity of the stereoscopic image pair and selects a minimum from the critical negative disparities of the critical horizontal disparity of the stereoscopic image pairs to form the optimum horizontal disparity interval.

22. A stereoscopic image shooting method, comprising:
capturing a plurality of multi-view images of an object; and
performing a score evaluation step to analyze a plurality of stereoscopic images selected from the plurality of multi-view images for calculating a stereoscopic quality score of the plurality of stereoscopic images.

23. The method according to claim 22, further comprising:
controlling the image capturing step to adjust shooting parameters according to the stereoscopic quality score.

24. The method according to claim 22, wherein the image capturing step further comprises:
changing a capturing distance relationship and/or a shooting angle relationship to the object.

25. The method according to claim 22, wherein the score evaluation step analyzes an optimum horizontal disparity score and/or a vertical disparity score and/or a stereoscopic window violation score and/or an overall score of the plurality of stereoscopic images of the object.

26. The method according to claim 25, wherein when the score evaluation step analyzes the vertical disparity score,
the score evaluation step locates and filters a plurality of feature point matches of a stereoscopic image pair, wherein the stereoscopic image pair is selected from the plurality of multi-view images;
the score evaluation step calculates respective vertical disparity of each feature point match of the stereoscopic image pair;
the score evaluation step calculates a ratio of high vertical disparity feature point matches of the stereoscopic image pair to total feature point matches of the stereoscopic image pair, wherein a high vertical disparity feature point match is defined as the feature point match having a vertical disparity larger than a vertical disparity threshold; and
the score evaluation step sums respective vertical disparity quantitative indicator of each stereoscopic image pair and outputs the vertical disparity score according to the sum.

27. The method according to claim 25, wherein when the score evaluation step analyzes the stereoscopic window violation score,
the score evaluation step calculates the stereoscopic window violation score according to a plurality of negative disparity pixels of a stereoscopic image pair within a range distant from an image border and absolute values of negative disparities of the plurality of negative disparity pixels, wherein the stereoscopic image pair is selected from the plurality of multi-view images;
the score evaluation step calculates respective stereoscopic window violation score of each negative disparity pixel, wherein the stereoscopic window violation score is associated with the absolute values of the negative disparities of the plurality of negative disparity pixels and a weight function related to a distance from one of the plurality of negative disparity pixels to the image border.

28. The method according to claim 25, wherein when the score evaluation step analyzes the optimum horizontal disparity score,
the score evaluation step pairs up the plurality of multi-view images into a plurality of stereoscopic image pairs;
the score evaluation step obtains respective critical horizontal disparity of the stereoscopic image pairs;
the score evaluation step compares the respective critical horizontal disparity of the stereoscopic image pairs to calculate an optimum horizontal disparity interval; and
the score evaluation step compares the optimum horizontal disparity interval with a tolerable disparity interval of a stereoscopic screen to obtain the optimum horizontal disparity score.

29. The method according to claim 28, wherein the score evaluation module obtains the respective critical horizontal disparity of the stereoscopic image pairs,
the score evaluation step analyzes and filters image features of the stereoscopic image pair;
the score evaluation step obtains a statistic information of disparities of the stereoscopic image pair according to the image features of the stereoscopic image pair; and
the score evaluation step determines the corresponding critical horizontal disparity of the stereoscopic image pair according to the statistic information of disparities, wherein the critical horizontal disparity comprises a critical positive disparity and a critical negative disparity.

30. The method according to claim 28, wherein when the score evaluation step compares the respective critical horizontal disparity of the stereoscopic image pairs to calculate an optimum horizontal disparity interval,
the score evaluation step selects a maximum from the critical positive disparities of the critical horizontal disparity of the stereoscopic image pairs and selects a minimum from the critical negative disparities of the critical horizontal disparity of the stereoscopic image pairs to form the optimum horizontal disparity interval.

31. The method according to claim 29, wherein
the score evaluation step analyzes the image features of the stereoscopic image pair according to a dense feature matching or a feature-based matching; and
the score evaluation step filters the image features of the stereoscopic image pair according to a disparity absolute distance parameter, a vertical disparity parameter and an epipolar geometry parameter.

32. A stereoscopic quality evaluation method for evaluating a plurality of stereoscopic sensing factors of a 3D display, the stereoscopic quality evaluation method comprising:
capturing a plurality of multi-view images from a 3D display device; and
performing a score evaluation step to analyze stereoscopic images of the plurality of multi-view images and output a score of the 3D display device.

33. The method according to claim 32, wherein the score evaluation step calculates an optimum horizontal disparity score and/or a vertical disparity score and/or a stereoscopic window violation score and/or a cross-talking score and/or an overall score of the plurality of multi-view images.

34. The method according to claim 33, wherein when the score evaluation step analyzes the vertical disparity score,
the score evaluation step locates and filters a plurality of corresponding feature point matches of a stereoscopic image pair, wherein the stereoscopic image pair is selected from the plurality of multi-view images;
the score evaluation step calculates respective vertical disparity of each corresponding feature point match of the stereoscopic image pair;
the score evaluation step calculates a ratio of high vertical disparity feature point matches of the stereoscopic image pair to total feature point matches of the stereoscopic image pair, wherein a high vertical disparity feature point match is defined as the feature point match having a vertical disparity larger than a vertical disparity threshold; and
the score evaluation step sums respective vertical disparity quantitative indicator of each stereoscopic image pair and outputs the vertical disparity score according to the sum.

35. The method according to claim 33, wherein when the score evaluation step analyzes the stereoscopic window violation score,
the score evaluation step evaluates based on a plurality of negative disparity pixels of a stereoscopic image pair within a range distant from an image border and absolute values of negative disparities of the plurality of negative disparity pixels, wherein the stereoscopic image pair is selected from the plurality of multi-view images;
the score evaluation step calculates respective stereoscopic window violation score of each negative disparity pixel, wherein the stereoscopic window violation score is associated with the absolute values of the negative disparities of the plurality of negative disparity pixels and a weight function related to a distance from one of the plurality of negative disparity pixels to the image border.

36. The method according to claim 33, wherein when the score evaluation step calculates the cross-talking score,
the score evaluation step calculates a corresponding region of a stereoscopic image pair, wherein the stereoscopic image pair is selected from the plurality of multi-view images;
the score evaluation step calculates color difference of the corresponding region of the stereoscopic image pairs to calculate a cross-talking quantitative indicator of two of the plurality of multi-view images; and
the score evaluation step calculates a sum of all cross-talking quantitative indicators of the stereoscopic image pairs to output the cross-talking score.

37. The method according to claim 33, wherein when the score evaluation step analyzes the optimum horizontal disparity score,
the score evaluation step pairs up the plurality of multi-view images into a plurality of stereoscopic image pairs;
the score evaluation step obtains respective critical horizontal disparity of the stereoscopic image pair;
the score evaluation step compares the respective critical horizontal disparity of the stereoscopic image pairs to calculate an optimum horizontal disparity interval; and
the score evaluation step compares the optimum horizontal disparity interval with a tolerable disparity interval of a stereoscopic screen to obtain the optimum horizontal disparity score.

38. The method according to claim 37, wherein when the score evaluation step obtains the respective critical horizontal disparity of the stereoscopic image pairs,
the score evaluation step analyzes and filters image features of the stereoscopic image pair;
the score evaluation step obtains a statistic information of disparities of the stereoscopic image pair according to the image features of the stereoscopic image pair; and
the score evaluation step determines the corresponding critical horizontal disparity of the stereoscopic image pair according to the statistic information of disparities, wherein the critical horizontal disparity comprises a critical positive disparity and a critical negative disparity.

39. The method according to claim 37, wherein when the score evaluation step compares respective critical horizontal disparity of the stereoscopic image pairs to calculate the optimum horizontal disparity interval, the score evaluation step selects a maximum from the critical positive disparities of the critical horizontal disparity of the stereoscopic image pairs and selects a minimum from the critical negative disparities of a critical horizontal disparity threshold of the stereoscopic image pairs to form the optimum horizontal disparity interval.
